(19) United States
(12) Patent Application Publication
(10) Pub. No.: US 2014/0342248 A1
(43) Pub. Date: Nov. 20, 2014

(54) FUEL CELL

(71) Applicant: TOYOTA JIDOSHA KABUSHI KAISHA, Toyota-shi, Aichi-ken (JP)

(72) Inventors: Noriko Kouno, Toyota-shi (JP); Takahiro Kusumegi, Toyota-shi (JP)

(73) Assignee: TOYOTA JIDOSHA KABUSHIKI KAISHA, Toyota-shi, Aichi-ken (JP)

(21) Appl. No.: 14/360,522

(22) PCT Filed: Nov. 29, 2012
(86) PCT No.: PCT/IB2012/002800

§ 371 Date: May 23, 2014

(30) Foreign Application Priority Data
Nov. 30, 2011 (JP) 2011-261760

(51) Int. Cl. H01M 8/16; H01M 8/10

(52) U.S. Cl. CPC H01M 8/16; H01M 8/1016; H01M 2300/0085; H01M 2300/0025
USPC 429/401; 429/482

(57) ABSTRACT

In a fuel cell (1) including an anode electrode (10), a cathode electrode (12), a membrane (14) which has ionic conductivity and is disposed between the anode electrode (10) and the cathode electrode (12), an ion-conductive gel-like substance (15) is held between the cathode electrode (12) and the membrane (14) having ionic conductivity.

### BACKGROUND OF THE INVENTION

1. Field of the Invention

The invention relates to a fuel cell having a structure in which an anode electrode and a cathode electrode are mutually opposed across a membrane having ionic conductivity.

2. Description of Related Art

Fuel cells with a structure in which an anode electrode and a cathode electrode are mutually opposed across a membrane having ionic conductivity are available in solid polymer fuel cells, for example. Fuel cells generally have a structure in which an anode electrode is arranged as a layer on one side of a membrane having ionic conductivity (e.g., an electrolyte membrane composed of an ion-exchange resin) and a cathode electrode is arranged as a layer on the other side of the membrane.

Fuel (e.g., hydrogen) is supplied to the anode electrode where, under the action of a catalyst, it becomes a proton (H⁺), and two electrons (e⁻) are released toward the cathode electrode. The proton produced at the anode electrode passes through a membrane having ionic conductivity and reaches the cathode electrode where, under the action of a catalyst, it accepts two electrons (e⁻) from the anode electrode and, together with an oxygen ion produced from externally supplied oxygen, produces water. The movement of electrons passing through this external circuit is extracted as an electrical current.

That is, the reaction H₂→2H⁺+2e⁻ arises on the anode side, and the reaction 2H⁺+1/2O₂+2e⁻→H₂O arises on the cathode side. Power is generated by the occurrence of, as the overall reaction, the reaction H₂+1/2O₂→H₂O. For the chemical reactions to proceed efficiently, as mentioned above, catalysts are used in the electrodes. For example, platinum is commonly used as a catalyst in solid polymer fuel cells.

In recent years, having focused on the fact that the biological metabolism which takes place in living organisms is a highly efficient energy conversion mechanism, energy researchers have endeavored to apply this mechanism to fuel cells. The advantages of biological metabolism include high energy utilization and the fact that the reactions proceed under moderate conditions at about room temperature. However, because many unnecessary reactions other than the reactions for converting chemical energy into electrical energy take place in microorganisms and cells, a sufficient energy conversion efficiency is not exhibited. Hence, fuel cells which carry out only the desired reactions using enzymes as the catalysts (biofuel cells) have been proposed. Such biofuel cells use enzymes that function as catalysts to break down a fuel, separating the fuel into protons and electrons. The fuel which has been developed as used in such fuel cells is an alcohol such as methanol and ethanol, a monosaccharide such as glucose, or a polysaccharide such as starch.

In biofuel cells, enzyme immobilization on the electrodes is very important and exerts a very large influence on, for example, the power characteristics, life and efficiency of the cell. It is thus highly important to minimize damage to the enzymes in the course of enzyme-immobilized electrode fabrication. To address this concern, Japanese Patent Application Publication No. 2009-48833 (JP-2009-48833 A) discloses a fuel cell in which enzymes have been immobilized at the positive electrode and the negative electrode with a photocurable resin or a thermoset resin. Japanese Patent Application Publication No. 2007-225444 (JP-2007-225444 A) discloses a fuel cell in which an enzyme has been immobilized on the anode electrode using a gel-like substance. It is anticipated that such a gel-like substance can serve as a practical substitute for an electrolyte solution at the anode electrode and also protect the enzyme. However, when a gel-like substance is used in place of an electrolyte solution, there is a risk of a decline in the ionic conductivity and a decrease in power output.

### SUMMARY OF THE INVENTION

Increased power output is desired both in fuel cells which use hydrogen as the fuel and a noble metal such as platinum as the catalyst, and also in fuel cells which use an alcohol, a monosaccharide such as glucose or a polysaccharide such as starch as the fuel, and an enzyme as the catalyst. The invention, which was conceived in light of the above circumstances in the art, provides a fuel cell that is capable of achieving an excellent power output compared with conventional fuel cells. The invention also provides a method of manufacturing such fuel cells.

The inventors have discovered that by interposing an ion-conductive gel-like substance between the membrane having ionic conductivity and the cathode electrode in conventional biofuel cells, the power-generating efficiency of the cell can be greatly improved.

In a first aspect, the invention provides a fuel cell which includes an anode electrode, a cathode electrode, a membrane which has ionic conductivity and is disposed between the anode electrode and the cathode electrode, and an ion-conductive gel-like substance which is held between the cathode electrode and the membrane having ionic conductivity.

In the fuel cell according to the above aspect of the invention, the anode electrode and the cathode electrode preferably each contain an enzyme as a catalyst. Moreover, carboxymethylcellulose (CMC) or sodium alginate may be used as the ion-conductive gel-like substance.

By virtue of the foregoing aspect of the invention, it is possible in a fuel cell with a structure in which an anode electrode and a cathode electrode are mutually opposed across an intervening membrane having ionic conductivity to achieve an improved power output. That is, the fuel cell according to the invention is able to exhibit an excellent power output compared with conventional fuel cells that do not apply this invention.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a diagram which schematically illustrates a fuel cell in which an embodiment of the invention has been applied;

FIG. 2 is a schematic diagram of a test cell constructed in an example of the invention; and

FIG. 3 is a graph which plots the measured power characteristics of the test cells built in the examples of the invention.

### DETAILED DESCRIPTION OF EMBODIMENTS

The fuel cell according to the invention is described more fully below in conjunction with the drawings.

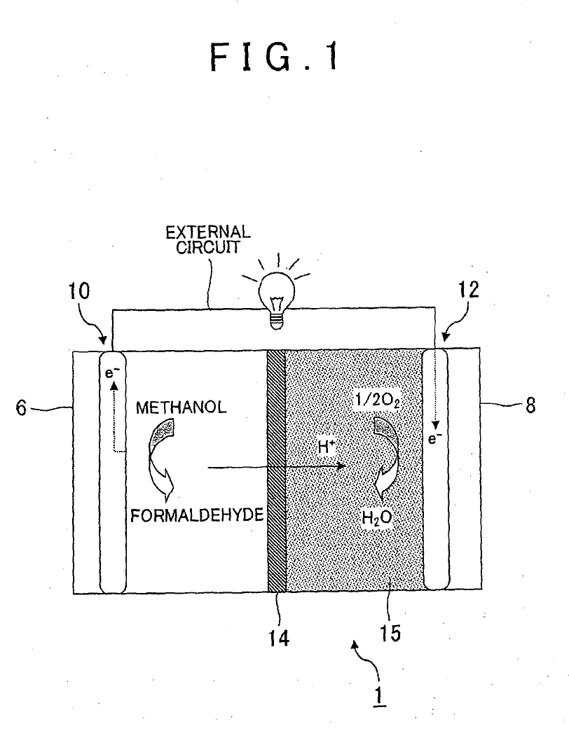

A fuel cell 1 according to the first aspect of the invention has, as shown schematically in FIG. 1, an anode electrode 10, a cathode electrode 12, a membrane 14 (referred to below as “the electrolyte membrane 14”) which has ionic conductivity and is disposed between the anode electrode 10 and the cathode electrode 12, and an ion-conductive gel membrane 15 which contains an ion-conductive gel-like substance and is situated between the cathode electrode 12 and the electrolyte membrane 14. That is, in the fuel cell 1 according to the invention, the ion-conductive gel membrane 15 is held between the cathode electrode 12 and the electrolyte membrane 14. Moreover, in the fuel cell 1, the anode electrode 10 is disposed at the interior of an anode electrode chamber 6, and the cathode electrode 12 is disposed at the interior of a cathode electrode chamber 8. Fuel is filled into or supplied to the anode electrode chamber 6.

Here, the ion-conductive gel membrane 15 may be produced using any gel-like substance, provided the substance has ionic conductivity. Illustrative examples of the gel-like substance include CMC, sodium alginate, agarose, polyacrylic acid, polyacrylamide, carrageenan, gelatin, polyhydroxyethyl methacrylate, gellan gum, poly(γ-glutamic acid), polyvinyl alcohol and polydextrose. By producing the ion-conductive gel membrane 15 using these gel-like substances, a semi-dry state can be achieved and maintained while retaining the minimum amount of moisture required for the enzyme reaction at the cathode electrode 12. Moreover, this gel-like substance preferably contains from 50 mM to 3,000 mM of electrolyte or buffer ingredients. For example, sodium, potassium and phosphoric acid may be used as the electrolyte and buffer ingredients. The thickness of the ion-conductive gel membrane 15, although not particularly limited, is preferably from about 1 μm to about 1 mm, and more preferably from about 1 μm to about 10 μm.

The ion-conductive gel membrane 15 may be produced by adding the desired amounts of electrolyte or buffer ingredients to the above-described gel-like substance, then casting the substance onto a main face of the cathode electrode 12 which lies opposite the electrolyte membrane 14 and/or a main face of the electrolyte membrane 14 which lies opposite the cathode electrode 12, and solidifying the substance. However, the method of producing the ion-conductive gel membrane 15 is not limited in any way to the foregoing method.

Here, the anode electrode 10 is composed of an electrode material and an oxidation reaction-related agent which includes an enzyme and a mediator. The mediator within the oxidation reaction-related agent at the anode electrode 10 is a bioprotein that is capable of electron transfer and carries out electron exchange between the oxidizing reaction-related agent enzyme and the electrode material. The bioprotein that is capable of electron transfer, although not subject to any particular limitation, includes metal-containing proteins which contain iron, copper or the like. Illustrative examples include hemoglobin, ferredoxin, cytochrome C511, cytochrome 450, azurin, plastocyanin, cytochrome a, a1, a3, b, b2, b3, b5, b6, b555, b559, b562, b563, b565, b566, c, c1, c2, c3, d, e, f, o, P-450, hemocyanin and ferritin.

More specific examples of bioproteins that are capable of electron transfer include bovine-derived hemoglobin (Nakalai Tesque), Clostridium-derived ferredoxin (SIGMA), Pseudomonas-derived cytochrome C551 (SIGMA), and Pseudomonas-derived azurin (SIGMA).

The enzyme within the oxidation reaction-related agent at the anode electrode 10 takes part in the oxidation reaction on fuel that is filled into or supplied to the anode electrode chamber 6, and is selected in accordance with the fuels listed below. For example, when methanol is used as the fuel, the enzyme may be alcohol dehydrogenase which oxidizes methanol to formaldehyde. When glucose is used as the. fuel, the enzyme may be glucose dehydrogenase, which oxidizes glucose to gluconolactone. These enzymes are preferably aldehyde dehydrogenase like (NAD)⁺-dependent dehydrogenase or pyrroloquinoline quinone (PQQ)-dependent dehydrogenase. NAD⁺-dependent dehydrogenase uses NAD⁺ (nicotinamide adenine dinucleotide) as a co-enzyme; the fuel oxidation reaction proceeds in the presence of NAD⁺. With the use of PQQ-dependent dehydrogenase, the fuel oxidation reaction proceeds even in the absence of the NAD⁺ coenzyme.

Specific examples include PQQ-dependent alcohol dehydrogenases from Acetobacter pasteurianus, Methylobacterium extorquens, Paracoccus denitrificans, Pseudomonas putida and Comamonas testosteroni (NBRC12048); and PQQ-dependent glucose dehydrogenases from Acinetobacter calcoaceticus and Escherichia coli.

Other examples of enzymes that may be used within the oxidation reaction-related agent include enzymes that take part in sugar metabolism (e.g., hexokinase, glucose phosphate isomerase, phosphofructokinase, fructose bisphosphate aldolase, triose phosphate isomerase, glyceraldehyde phosphate dehydrogenase, phosphoglyceromutase, phosphopyruvate hydratase, pyruvate kinase, L-lactate dehydrogenase, D-lactate dehydrogenase, pyruvate dehydrogenase, citrate synthase, aconitase, isocitrate dehydrogenase, 2-oxoglutarate dehydrogenase, succinyl-CoA synthetase, succinate dehydrogenase, fumarase and malonate dehydrogenase).

The fuel that is filled into or supplied to the anode electrode chamber 6 is exemplified by alcohols such as methanol, saccharides such as glucose, and organic acids that are intermediate products of fat, protein or carbohydrate metabolism (e.g., glucose-6-phosphoric acid, fructose-6-phosphoric acid, fructose-1,6-bisphosphoric acid, triose-phosphate, 1,3-bisphosphoglyceric acid, glycerate 3-phosphate, 2-phosphoglycerate, phosphoenolpyruvic acid, pyruvic acid, acetyl-CoA, citric acid, cis-aconitic acid, isocitric acid, oxalosuccinic acid, 2-oxoglutaric acid, succinyl-CoA, succinic acid, fumaric acid, L-malic acid, oxaloacetic acid), as well as mixtures thereof.

From the standpoint of enabling the uptake or immobilization of more enzyme and mediator-containing oxidation reaction-related agent, it is preferable for the electrode material used to be a porous material, such as carbon felt, carbon paper or activated carbon.

The anode electrode 10, although not particularly limited, may be produced by using a polymer or a crosslinking agent to immobilize an enzyme and mediator-containing oxidation reaction-related agent on the electrode material. Alternatively, the anode electrode 10 may be produced by dissolving an enzyme and mediator-containing oxidation reaction-related agent in a buffer solution, and immersing the electrode material in the resulting solution. Illustrative examples of polymers that may be used here include polyvinyl imidazole, polyallylamine, polyamino acids, polypyrrole, polyacrylic acid, polyvinyl alcohol, graft copolymers of polypropylene and maleic anhydride, copolymers of methyl vinyl ether and maleic anhydride, and o-cresol novolak-type epoxy resins. Illustrative examples of crosslinking agents that may be used include polyethylene glycol diglycidyl ether, glutaraldehyde, disuccimidyl suberate and succimidyl-4-(p-maleimidophenyl) butyrate. In addition, illustrative examples of buffer solutions that may be used include 3-(N-morpholino) propanesulfonic acid (MOPS) buffer solutions, phosphate buffer solutions and tris buffer solutions.

Next, the cathode electrode 12 is described. The cathode electrode 12 is composed of an electrode material and a reducing reaction-related agent. The reducing reaction-related agent used at the cathode electrode 12 may be one composed of, as the electrode catalyst, either carbon powder on which a metal catalyst such as platinum has been supported or oxidoreductase, and a mediator.

Examples of oxidoreductases which may be used in the reducing reaction-related agent include bilirubin oxidase, laccase and peroxidase. Mediators that may be used are exemplified by the same as those described above. In cases where the reducing reaction-related agent is composed of a carbon powder on which a metal catalyst has been supported, examples of metal catalysts that may be used include platinum, iron, nickel, cobalt and ruthenium. Illustrative examples of the carbon powder include carbon blacks such as acetylene black, furnace black, channel black and thermal black.

A reaction which produces water from oxygen and protons proceeds at the cathode electrode 12 within the cathode electrode chamber 8. Hence, there is a need to have oxygen for use in the reaction supplied to the cathode electrode 12. Moisture present in the ion-conductive gel membrane 15 or dissolved oxygen within the buffer solution can be used in this reaction at the fuel cell according to the invention. Alternatively, the oxygen used in this reaction may be supplied by introducing an oxygen-containing gas (e.g., air) into the cathode electrode chamber 8. Another possibility is to feed into the cathode electrode chamber 8 an oxygen-containing buffer solution to which a sacrificial reagent such as potassium ferricyanide has been added. Or, if the reducing reaction-related agent in the cathode electrode 12 is a carbon powder which supports a metal catalyst such as platinum, use may be made of oxygen gas.

In cases where an oxidoreductase and a mediator are used as the reducing reaction-related agent, the cathode electrode 12 may be produced by, as with the above-described anode electrode 10, using a polymer and a crosslinking agent to immobilize the oxidoreductase and the mediator on the electrode material. Alternatively, the cathode electrode 12 may be produced by dissolving the oxidoreductase and the mediator in a buffer solution, then immersing the electrode material in the resulting solution. The polymer, crosslinking agent and buffer solution used here may be the same as those used in the above-described anode electrode 10. On the other hand, in cases where use is made of a carbon powder on which a metal catalyst has been supported, the cathode electrode 12 can be produced by using an electrolyte (e.g., a perfluorocarbon sulfonic acid electrolyte) similar to the subsequently described electrolyte membrane 14 to immobilize the metal catalyst-supporting carbon powder on the electrode material.

The electrolyte membrane 14 is not subject to any particular limitation, provided it has proton conductivity and lacks electron conductivity. Illustrative examples include perfluorocarbon sulfonic acid resin membranes, trifluorostyrene derivative copolymer membranes, phosphoric acid-impregnated polybenzimidazole membranes and aromatic polyetherketone sulfonic acid membranes. A specific example of an electrolyte membrane that may be used is Nafion®.

In the fuel cell 1 of the invention constituted as described above, when the fuel supplied to the anode electrode 10 is methanol, the redox reactions at the anode electrode 10 and the cathode electrode 12 are expressed by formulas (1) and (2) below.

Anode: CH₃OH→HCHO+2H⁺+2e⁻ (1)

Cathode: 2H⁺+1/2O₂+2e⁻→H₂O (2)

That is, at the anode electrode 10, a reaction is carried out in which the enzyme decomposes methanol into formaldehyde, hydrogen ions and electrons. The electrons are carried by the mediator to the electrode material, and are carried over an external circuit to the cathode electrode 12. The hydrogen ions migrate to the cathode electrode 12 through the electrolyte membrane 14. Meanwhile, at the cathode electrode 12, a reaction is carried out in which the hydrogen ions, electrons and oxygen react to produce water. By means of these reactions, energy is extracted to the external circuit.

In particular, the fuel cell according to the invention increases the cell power compared with conventional fuel cells. Here, “conventional fuel cells” refers to fuel cells having a structure which, aside from lacking an ion-conductive gel membrane 15 between the cathode electrode 12 and the electrolyte membrane, is substantially the same as that of the inventive fuel cell. Although the mechanism whereby the cell power rises with the presence of an ion-conductive gel membrane 15 is not well understood, it is thought to be due to increased contact between the semi-dry state cathode electrode 12 and the electrolyte membrane 14.

### EXAMPLES

Fuel cells according to one aspect of the invention are described in greater detail below by way of examples, although the technical scope of the invention is not limited by the following examples.

### Example 1

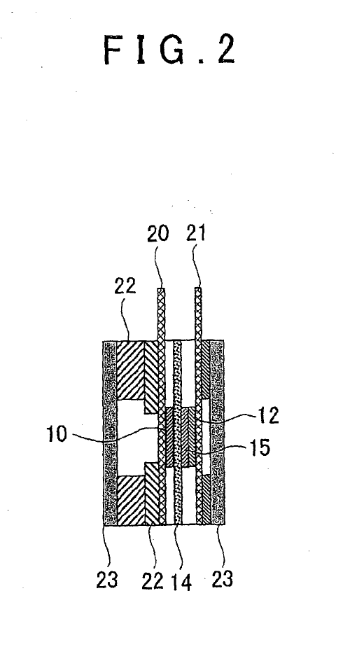

In this example, a test cell like that shown schematically in FIG. 2 was fabricated, and the power characteristics were evaluated. The test cell shown in FIG. 2 has a structure in which an anode electrode 10 and a cathode electrode 12 are mutually opposed across an electrolyte membrane 14. In addition, an ion-conductive gel membrane 15 is present between the cathode electrode 12 and the electrolyte membrane 14. The test cell shown in FIG. 2 has an anode-side current collector 20 disposed so as to be in contact with the anode electrode 10, and a cathode-side current collector 21 disposed so as to be in contact with the cathode electrode 12. In addition, the test cell shown in FIG. 2 is configured such that a stacked structure composed of the anode-side current collector 20, anode electrode 10, electrolyte membrane 14, ion-conductive gel membrane 15, cathode electrode 12 and cathode-side current collector 21 is inserted within silicon 22, and the silicon 22 is in turn inserted between a pair of acrylic plates 23.

In this example, the test cell was fabricated using sodium alginate gel as the ion-conductive gel membrane 15.

### (1-1) Production of Anode Electrode 10

A dispersion obtained by the intimate mixture of carbon black, 10% polyvinyl pyridine and N-methylpyrrolidone was coated onto a piece of carbon felt cut to a size of 1 cm², and the coated felt was dried to form an anode electrode 10.

### (1-2) Production of Cathode Electrode 12

A dispersion obtained by the intimate mixture of carbon black, Teflon and 2-propanol was coated onto a piece of carbon felt cut to a size of 1 cm², and the coated felt was dried to form an cathode electrode 12.

### (1-3) Production of Sodium Alginate Gel

A solution of 100 mg of sodium alginate dissolved in 3.2 ml of sodium phosphate buffer (pH 7) was used as the sodium alginate gel.

### (1-4) Production of Test Cell Using Sodium Alginate Gel

The test cell was produced by coating the gel produced in (1-3) between the cathode electrode 12 and the electrolyte membrane 14, thereby forming the ion-conductive gel membrane 15. In the resulting test cell, the anode electrode was filled with a 2M sodium ascorbate solution, and the cathode electrode was filled with 200 mg/mL BO-3 (from Amano Enzyme, Inc.) and a 50 mM potassium ferricyanide solution.

### (1-5) Evaluation of Fuel Cell

The test cell was connected in series to an external load via the anode-side current collector 20 and the cathode-side current collector 21 in the test cell produced above in (1-4). The power characteristics of the test cell were measured using a PLZ-164WA Electronic Load (from Kikusui Electronics Corp.) as the external load and using Wavy for PLZ-4W software (from Kikusui Electronics Corp.). Measurements were carried out under room temperature conditions (about 25° C.).

### Example 2

In this example, aside from using CMC gel as the material of the ion-conductive gel membrane 15, a test cell was produced in the same way as in Example 1 and the power characteristics of the test cell were measured. Specifically, a solution of 100 mg of CMC dissolved in 2 ml of sodium phosphate buffer (pH 7) was prepared as the CMC gel. This gel was coated between the cathode electrode 12 and the electrolyte membrane 14, thereby forming an ion-conductive gel membrane 15.

### Comparative Example 1

A test cell lacking an ion-conductive gel membrane 15 was produced as a comparative example. That is, the test cell produced as the comparative example was configured such that, in the structure shown in FIG. 2, the electrolyte membrane 14 and the cathode electrode 12 were in direct contact with no ion-conductive gel membrane 15 therebetween.

### Results of Evaluation of Characteristics

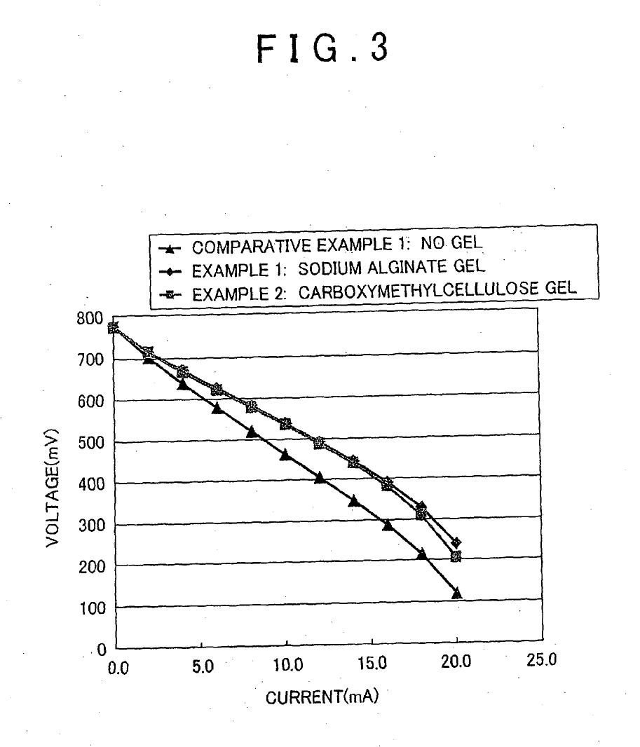

The power characteristics of the test cell produced in Example 1, the test cell produced in Example 2 and the test cell produced in Comparative Example 1 were evaluated by the method described above in section (1-5) of Example 1. The results are shown in FIG. 3.

As shown in FIG. 3, the test cell produced in Example 1 had a power output of 6.25 W/cm², and the test cell produced in Example 2 had a power output of 6.15 W/cm². By contrast, the test cell produced in Comparative Example 1 had a power output of 4.9 mW/cm². It is apparent from these results that the cell power can be greatly increased by interposing the ion-conductive gel membrane 15 between the electrolyte membrane 14 and the cathode electrode 12.

1. A fuel cell having an anode electrode, a cathode electrode, and a membrane which has ionic conductivity and is disposed between the anode electrode and the cathode electrode,
the fuel cell comprising:
an ion-conductive gel-like substance which is held between the cathode electrode and the membrane having ionic conductivity
wherein the ion-conductive gel-like substance is carboxymethylcellulose (CMC) or sodium alginate.

2. The fuel cell according to claim 1, wherein the anode electrode and the cathode electrode each contain an enzyme as a catalyst.

3. (canceled)
